(19) United States
(12) Patent Application Publication
(10) Pub. No.: US 2008/0095895 A1
(43) Pub. Date: Apr. 24, 2008

(54) Apparatus for making ice cream sandwiches with servo-driven sandwich elevator

(76) Inventor: Martin J. Mueller, Oldsmar, FL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/583,294

(22) Filed: Oct. 19, 2006

(51) Int. Cl. A23B 4/00

(52) U.S. Cl. 426/92

(57) ABSTRACT

An apparatus for making ice cream sandwiches includes a dispensing nozzle which dispenses ice cream between an associated pair of wafers, with each ice cream sandwich thereafter transferred to an associated sandwich wrapper for individually wrapping each sandwich. Wrapping is effected by vertically moving each sandwich through a wrapping chute on a sandwich elevator. Efficient operation of the present apparatus is facilitated by the provision of a servo-drive for the sandwich elevator, whereby the acceleration and deceleration of each sandwich can be controlled independently of the drive of other components of the apparatus.

### TECHNICAL FIELD

The present invention relates generally to an apparatus for making comestibles such as ice cream novelties, and in particular, ice cream sandwiches, and more particularly to an apparatus for making ice cream sandwiches including a servo-driven elevator for vertically moving each individual sandwich into an associated wrapping machine chute, whereby the vertical movement of each sandwich can be precisely controlled independently of operation of remaining components of the apparatus.

### BACKGROUND OF THE INVENTION

Machines for making ice cream confections, such as ice cream sandwiches, are well-known in the prior art. Typically, this type of machine includes an ice cream dispensing nozzle positioned in operative association with a pair of wafer trays or magazines, whereby ice cream is dispensed between a respective paid of wafers, with individual sandwiches thereafter conveyed to an associated wrapping mechanism, for subsequent cartoning, storage, and shipment.

U.S. Pat. No. 2,794,404, to Rapp, U.S. Pat. No. 3,119,353, to Roehn, U.S. Pat. No. 3,316,860, to Peterson, U.S. Pat. No. 3,600,875, to Buob, U.S. Pat. No. 3,828,660, to Mueller, U.S. Pat. No. 4,078,362, to Ellis, U.S. Pat. No. 3,834,119, to Armitt, U.S. Pat. No. 4,098,057, to Holcomb, U.S. Pat. No. 5,583,933, to Price, U.S. Pat. No. 4,612,852, to Price, U.S. Pat. No. 5,495,957, to Kennedy, U.S. Pat. No. 5,540,141, to Grubzak, and U.S. Pat. No. 6,016,639, to Spencer, all hereby incorporated by reference, illustrate ice cream sandwich making machines generally as described hereinabove.

As will be appreciated, it is desirable to operate machines of this nature as quickly as possible to facilitate manufacturing efficiency, but at the same time, the relatively fragile nature of the product being made acts to limit forming speeds. Hard dry wafers typically are surrounding soft, cold ice cream, with manufacture requiring that each sandwich be individually wrapped as efficiently as possible.

One of the primary obstacles to increasing the operating speed of these types of machines is an elevator mechanism which elevates each sandwich upwardly and through an associated wrapping chute. A very rapid ascent is necessary to facilitate efficient operation, and such motion is typically at the mechanical limits of cams or other mechanical components employed for operating the elevator, especially considering the delicate and fragile nature of the article being handled. Typically, machines of the above type include drive components, including the elevator mechanism, which are driven from a common drive of the apparatus, in unison with each other.

The present invention is intended to promote efficient making of ice cream sandwiches by facilitating precise and efficient control of the elevator mechanism of the apparatus.

### SUMMARY OF THE INVENTION

An apparatus for making wrapped ice cream sandwiches in accordance with the present invention includes a dispensing nozzle positioned in operative association with a pair of wafer magazines or trays, with components of the apparatus provided for receiving individual sandwiches, and transferring the sandwiches to an associated sandwich wrapper. The sandwich wrapper includes a sandwich elevator configured in accordance with the present invention, which is servo-driven so that the elevator can be operated independently of the associated components of the apparatus. By this arrangement, acceleration and deceleration of each sandwich on the sandwich elevator can be effected independently of the drive of the other components of the apparatus, thereby facilitating efficient handling and wrapping of the sandwiches, while avoiding undesirable damage to the sandwiches.

In accordance with the illustrated embodiment, the present apparatus includes a pair of wafer magazines for respectively retaining a plurality of wafers, and a dispensing nozzle positioned generally intermediate of the wafer magazines for dispensing ice cream between a respective pair of the wafers. In this manner, the apparatus functions to sequentially form a plurality of sandwiches each comprising a pair of wafers with ice cream therebetween.

A transfer rotor positioned beneath the wafer magazines receives each of the sandwiches, and transfers each sandwich to an associated conveyor. The sandwiches are thereafter conveyed to an associated sandwich wrapper positioned downstream of the sandwich conveyor.

The sandwich wrapper includes a sandwich elevator which sequentially receives each sandwich from the conveyor, and elevates each sandwich vertically for wrapping in wrapping material. Notably, the sandwich elevator includes a servo-drive operable independently of the drive of the transfer rotor and conveyor, as well as independently of other components of the apparatus which are typically operated by a single drive. In this fashion, the elevator can be operated to control acceleration and deceleration of each sandwich independently of the drive of the other components of the apparatus.

Notably, a feedback signal from the servo-driven sandwich elevator can be monitored to determine a force being exerted on each sandwich by the elevator. Thus, not only is it possible to adjust acceleration and deceleration of each sandwich, but by receiving feedback from the unit, it is almost as if the elevator “touches” each sandwich, with monitoring of force permitting the weight of ice cream to be calculated, and facilitating exertion of the proper amount of pressure to safely transport the assembled sandwich through the wrapping chute. The mechanism of the present invention desirably not only increases the speed performance of the apparatus, but also the sensitivity of the elevator. In distinction, previously known arrangements undesirably act to limit the speed of the apparatus, and because of the abrupt nature by which they are operating, can undesirably damage the sandwiches.

The mechanism of the present invention provides for controlled acceleration of the elevator with out abrupt stopping of the elevator. The elevator can be initially elevated at comparatively slow speeds, then accelerated to comparatively higher speeds, then slowed to comparatively slower speeds before stopping at a fully elevated position. Controlled acceleration of the elevator can result in less breakage of the sandwich wafers.

Other features and advantages of the present invention will become readily apparent from the following detailed description, the accompanying drawing, and the appended claims.

### BRIEF DESCRIPTION OF THE DRAWINGS

FIG. 1 is a diagrammatic view of an apparatus for making ice cream sandwiches embodying the principals of the present invention.

### DETAILED DESCRIPTION

While the present invention is susceptible of embodiment in various forms, there is shown in the drawing, and will hereinafter be described, a presently preferred embodiment, with the understanding that the present disclosure is to be considered as an exemplification of the invention, and is not intended to limit the invention to the specific embodiment illustrated.

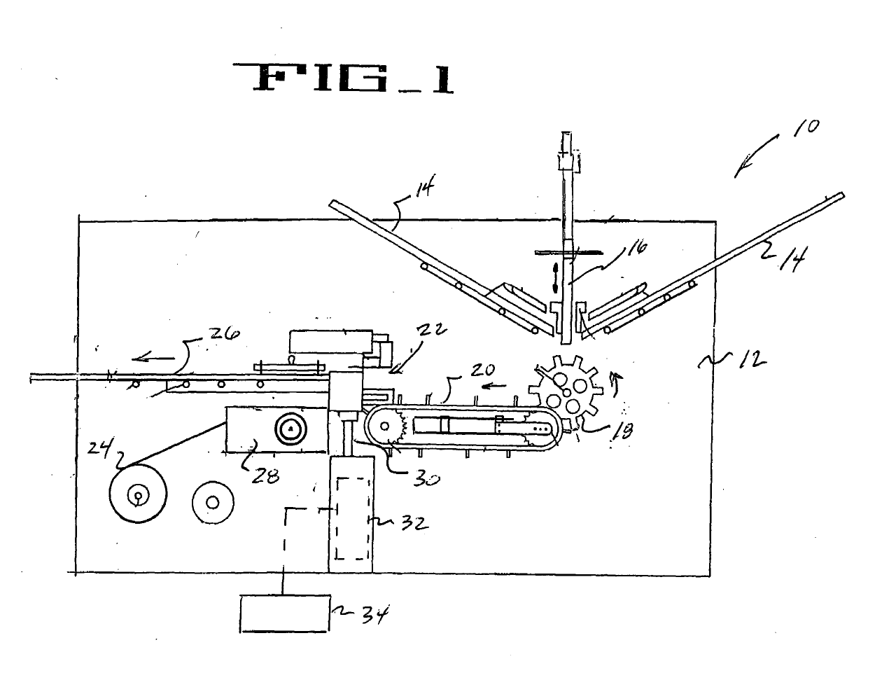

With reference to FIG. 1, therein is illustrated an apparatus 10 for making ice cream novelties, in particular, ice cream sandwiches, embodying the principals for the present invention. The apparatus 10 includes a frame 12 upon which are mounted a pair of wafer trays 14 arranged in generally downwardly converging relation for gravity-feed of wafers for formation of the ice cream sandwiches. A vertically reciprocable dispensing nozzle 16 dispenses ice cream between a respective paid of wafers from the trans 14, with each sandwich thus formed with a pair of outer wafers, with ice cream therebetween.

As each sandwich is formed, it is received on a transfer rotor 18 positioned generally beneath wafer magazines 14. The transfer rotor moves each sandwich through an arc of approximately 90 degrees (counterclockwise in the illustrated embodiment), and sequentially transfers the sandwiches to an associated sandwich conveyor 20. The sandwiches are thereafter sequentially conveyed to a wrapper mechanism, indicated generally at 22, where each sandwich is individually wrapped with wrapping material from a supply roll 24, with each wrapped sandwich thereafter moved out of the apparatus along a discharge 26 to an associated apparatus for cartoning, storage, and shipment.

Sandwich wrapper 22 includes a cutting mechanism 28 which cuts individual pieces of the wrapping material for individually wrapping each sandwich, and further includes a vertically reciprocable sandwich elevator 30 for moving each sandwich vertically through a wrapping chute at which the wrapping material is positioned. Suitable mechanisms of the sandwich wrapper appropriately fold and tuck the wrapping material around each sandwich.

In accordance with the present invention, sandwich elevator 30 includes a servo-drive 32, operated by suitable controls 34 whereby the sandwich elevator can be operated independently of other components of the apparatus 10. Typically, other components of the apparatus, including the transfer rotor 18 and sandwich conveyor 20 are operated by a single, common drive in unison with each other.

Operation of sandwich conveyor 30 by servo-drive 32 greatly facilitates efficient and versatile operation of the apparatus 10. While it is desirable to elevate each sandwich as quickly as possible on the elevator 30, elevator mechanisms which are operated by cams, or like mechanical components, typically have certain limits to their operating speeds if damage to the relatively fragile sandwich is to be avoided.

In significant distinction, the present invention permits the acceleration and deceleration of each sandwich to be controlled as desired, independently of drive of the other components of the apparatus.

Notably, servo-drive of the elevator 30 desirably provides a feedback signal to controls 34 which can be monitored to determine the force being exerted on each sandwich by the elevator. Thus, the feedback signal can be monitored to calculate the weight of ice cream being dispensed into each sandwich, and permit operation of the servo-drive 32 to exert the proper amount of pressure to safely transport the assembled sandwich through the wrapping chute. The system can thus be operated generally in accordance with the teachings of U.S. Pat. No. 5,787,687, hereby incorporated by reference, which has been found to facilitate desirably versatile operation of an ice cream dispensing apparatus.

From the foregoing, it will be observed that numerous modifications and variations can be effected without departing from the true spirit and scope of the novel concept of the present invention. It is to be understood that no limitation with respect to the specific embodiment illustrated herein is intended or should be inferred. The disclosure is intended to cover, by the appended claims, all such modifications as fall within the scope of the claims.

What is claimed is:

1. An apparatus for making wrapped ice cream sandwiches, comprising:
a pair of wafer magazines for respectively retaining a plurality of wafers;
a dispensing nozzle positioned generally intermediate of said wafer magazines for dispensing ice cream between respective pairs of said wafers to sequentially form a plurality of said sandwiches each comprising a pair of said wafers with ice cream therebetween;
a transfer rotor positioned beneath said wafer magazines for receiving each of said sandwiches;
a sandwich conveyor for sequentially receiving said sandwiches from said transfer rotor for advancement therefrom;
a sandwich wrapper positioned downstream of said sandwich conveyor for sequentially receiving said sandwiches from said conveyor for individually wrapping each sandwich;
said wrapper including a sandwich elevator for sequentially receiving each said sandwich from said conveyor, and elevating each sandwich vertically for wrapping in wrapping material,
said sandwich elevator including a servo-drive operable independently of a drive for said transfer rotor and conveyor, to thereby control acceleration and deceleration of each sandwich on said sandwich elevator independently of the drive other components of said apparatus.

2. A method of making wrapped ice cream sandwiches, comprising:
providing an apparatus, including providing a pair of wafer magazines for respectively retaining a plurality of wafers;
providing a dispensing nozzle positioned generally intermediate of said wafer magazines, and dispensing ice cream between respective pairs of said wafers to sequentially form a plurality of said sandwiches each comprising a pair of said wafers with ice cream therebetween;
providing a transfer rotor positioned beneath said wafer magazines, and receiving each of said sandwiches on said transfer rotor;
providing a sandwich conveyor, and sequentially receiving said sandwiches from said transfer rotor for advancement along said conveyor;
providing a sandwich wrapper positioned downstream of said sandwich conveyor for sequentially receiving said sandwiches from said conveyor for individually wrapping each sandwich;
said wrapper including a sandwich elevator for sequentially receiving each said sandwich from said conveyor, and elevating each sandwich vertically for wrapping in wrapping material, and
operating sandwich elevator independently of a drive for said transfer rotor and conveyor, to thereby control acceleration and deceleration of each sandwich on said sandwich elevator independently of the drive other components of said apparatus.

3. A method of making wrapped ice cream sandwiches in accordance with claim 1, including,
monitoring feedback from said sandwich elevator to determine a force being exerted on each said sandwich by said elevator.

4. A method of making wrapped ice cream sandwiches in accordance with claim 2, including,
monitoring feedback from said sandwich elevator to determine a force being exerted on each said sandwich by said elevator.
